(19) United States
(12) Patent Application Publication
(10) Pub. No.: US 2015/0140186 A1
(43) Pub. Date: May 21, 2015

(54) CLOSTRIDIUM BOTULINUM CONTROL IN MIDLY PROCESSED REFRIGERATED FOOD PRODUCTS

(71) Applicants: Arne Olav Sliekers, Breda (NL); Johanna Gerarda Elisabeth Wijman, Gorinchem (NL); Kumar Saurabh, Overland Park, KS (US)

(72) Inventors: Arne Olav Sliekers, Breda (NL); Johanna Gerarda Elisabeth Wijman, Gorinchem (NL); Kumar Saurabh, Overland Park, KS (US)

(73) Assignee: PURAC BIOCHEM B.V., Gorinchem (NL)

(21) Appl. No.: 14/540,516

(22) Filed: Nov. 13, 2014

Related U.S. Application Data
(60) Provisional application No. 61/904,537, filed on Nov. 15, 2013.

(30) Foreign Application Priority Data
Nov. 15, 2013 (EP) 13193089.3

(51) Int. Cl. A23L 3/3463; A01N 37/10; A01N 43/90; A23L 1/39; A01N 37/02

(52) U.S. Cl. CPC A23L 3/34635; A23L 1/39; A01N 37/02; A01N 43/90; A01N 37/10; A23V 2002/00
USPC 426/326; 426/532; 514/2.4

(57) ABSTRACT

The protection of low-acid, high moisture and/or high water activity processed food products against outgrowth of Clostridium botulinum. It was surprisingly found that combinations of propionic acid and/or a salt thereof with nisin are very effective in preventing Clostridium botulinum outgrowth. In certain embodiments, cinnamic acid and/or a salt thereof can be added to these combinations to give particularly good results. These combinations provide a preservative system that is particularly effective against Clostridium botulinum outgrowth. The use of these preservative systems in food products that are conductive to Clostrisium botulinum outgrowth. The food products including these preservative systems and the methods of producing them.

### FIELD OF THE INVENTION

The present invention concerns the field of food preservation, in particular the protection of low-acid, high moisture and/or high water activity processed food products against outgrowth of Clostridium botulinum. The present invention provides a preservative system that is particularly effective against Clostridium botulinum outgrowth. The use of these preservative systems is provided in food products that are particularly conductive to Clostridium botulinum outgrowth. The invention also provides the resulting food products and the methods of producing them.

### BACKGROUND OF THE INVENTION

Clostridium botulinum is an anaerobic, gram-positive, spore-forming rod that produces a potent neurotoxin. Seven types of botulinum toxins are recognized (A, B, C, D, E, F and G), based on the antigenic specificity. Types A, B, E and F cause human botulism. Botulism is a serious disease, which is generally fatal in 5% to 10% of cases. Foodborne botulism is a severe type of food poisoning caused by ingestion of foods containing the toxin produced by C. botulinum. This type of botulism most often develops after consumption of improperly processed and inadequately cooked home-preserved foods. Occasionally, commercially produced food products have been associated with botulism outbreaks. Despite the low incidence, the risk of C. botulinum poisoning is a serious concern for commercial food processors because of the potentially severe consequences.

Almost any type of food that is not very acidic (pH above 4.6) or dry (Aw above 0.94) can support growth and toxin production by C. botulinum. Salt concentrations of above 4% inhibit spores (especially regarding type E), with a 5% concentration completely inhibiting their growth. Pickled, brined and/or dried food products are therefore not usually associated with botulism risks.

For food products that are conductive to Clostridium botulinum outgrowth and toxin production, the most common approach has been high temperature processing. Clostridium botulinum, considered the most heat resistant of dangerous bacteria in foods deriving from its ability to form highly heat resistant spores that survive lesser processes. Inactivation of the bacterial spores therefore constitutes the main challenge. In the food canning industry, for example, the dangers of permitting the survival of Clostridium botulinum spores are such that a probability of contamination of 10⁻¹² is aimed for. This is termed “commercial sterility”

Food products that are ready to eat or easy to prepare and at the same time have a ‘fresh-like’ quality, are among the most rapidly growing segments of the food processing industry. These food products typically have salt contents, water activities and pH values that make them conductive to Clostridium botulinum outgrowth. In order to meet the consumers demand for enhanced quality, the application of treatments sufficient for “commercial sterility” is however not an option, as it will result in loss of sensory and nutritional characteristics of the ingredients. For control of microbial growth, these products therefore usually depend on refrigeration. This requires very strict temperature control though and products that rely solely on refrigeration for safety have been involved in botulism outbreaks. At the same time, in this particular product category, being able to extend the product's “use by” date is probably one of the greatest marketing advantages. Not surprisingly, extensive efforts have been made to develop food grade compositions that can function as antibacterial agents in these mildly processed refrigerated food products.

A traditional chemical approach for preventing growth of Clostridium botulinum and the production of botulinum toxin has been to add sodium nitrite. Concerns about the use of nitrites in (cooked) food products grew over the years however, and various attempts have been made to accomplish effective control of Clostridium botulinum outgrowth with reduced nitrite concentrations. In the methods of U.S. Pat. No. 4,342,789 sorbate is combined with a nitrite curing agent. In U.S. Pat. No. 4,443,484 the compound 3-(4-tolylsulfonyl) acrylonitrile is employed to substitute part of the sodium nitrite.

In U.S. Pat. No. 5,017,391 compositions and methods using lactate salts are disclosed to delay Clostridium botulinum growth in a foodstuff such as fish or poultry. The foods are heated to a temperature sufficient to cook the meat but not to sterilize the product. Lactate may be used alone, or in combination with other agents such as sodium nitrite.

U.S. Pat. No. 6,613,364 concerns the use of nisin-containing whey derived from a nisin-producing culture to cooked meat or cooked meat-vegetables-and-sauce combinations, in order to prevent in particular Clostridium botulinum outgrowth. Intriguingly, according to U.S. Pat. No. 6,613,364 the addition of purified nisin and lactate are ineffective in conferring the protective benefit attained with the nisin containing whey and it is suggested that additional components not yet identified may contribute to the beneficial effects.

In U.S. Pat. No. 6,991,820 antibacterial compositions are disclosed containing at least one propionibacterial metabolite and at least two additional components selected from the group consisting of (a) lantibiotics, (b) lytic enzymes and (c) organic acids and/or organic acid salts, which is said to be effective in being both bacteristatic and bactericidal to potentially harmful food-borne pathogenic bacteria, when used in conjunction with one or more sublethal processing treatments.

Clearly, consumer interest in mildly processed refrigerated food products is driving processors to develop new procedures and additives for optimal inhibition or prevention of Clostridium botulinum outgrowth. There is, obviously, a particular desire to accomplish this using additives that can be ‘labeled’ as natural. Any ingredient used ideally should not negatively interfere with the organoleptic properties of the products, i.e. when used at effective levels.

It is the objective of the present invention to fulfill one or more of these needs.

### SUMMARY OF THE INVENTION

The present inventors surprisingly found that this objective could be accomplished with a preservative system comprising propionic acid and/or one or more salts thereof in combination with nisin.

As is demonstrated in the appending examples such preservative systems were highly effective in preventing Clostridium botulinum outgrowth in a soup sample, compared to control. To the inventors knowledge the effectiveness of propionate-nisin combinations in inhibiting Clostridium botulinum has not been reported before.

Particularly good results were furthermore obtained with preservative systems further comprising cinnamic acid and/or cinnamic acid salts. To the inventors knowledge the effectiveness of cinnamic acid and/or salts thereof in inhibiting Clostridium botulinum has not been reported before. Clostridium botulinum and its non toxin forming strain, usually called Clostridium sporogenes, themselves can produce cinnamic acid. It was therefore entirely contrary to the inventor's expectations that cinnamic acid further enhanced the effectiveness of the present preservative systems.

Hence, the present invention provides the preservative systems that can be used to extend the shelf-life of mildly treated refrigerated or chilled food products, in particular with a view to the risk of foodborn botulism. The use of these preservative systems, the food products containing them, and methods of treating food products are also provided.

These and other aspects of the invention will be described and illustrated in more detail in the following sections.

### DETAILED DESCRIPTION OF THE INVENTION

A first aspect, the present invention provides a food preservative system comprising propionic acid and/or one or more propionic acid salts in combination with nisin.

As used herein the term ‘preservative system’ encompasses any composition that contains the preservative agent of this invention either alone or in combination with other preservative agents, which composition is in a form that makes it suitable for use as a preservative agent, preferably for incorporation in a food product. Hence the preservative system may e.g. be pure or substantially pure cinnamic acid or a pure or substantially pure cinnamic acid salt or a composition, preferably a food-grade composition, comprising cinnamic acid and/or cinnamic acid salts in combination with other preservatives and/or a carrier material.

The preservative system of the invention comprises propionic acid (or propanoic acid) and/or one or more salts thereof. Propionic acid and propionic acid salts may also be collectively referred to herein as ‘propionate’. Typically, the salt can be a water soluble salt of propionic acid, such as sodium propionate, calcium propionate and potassium propionate. In accordance with the present invention, the preservative system preferably comprises propionic acid, sodium propionate, calcium propionate, potassium propionate or a mixture of two or more of said agents.

In one preferred embodiment, the preservative system comprises propionate, preferably in the form of propionic acid and/or a propionic acid salt, in an amount of more than 0.1 wt. %, based on the total weight of the preservative system, preferably more than 0.25 wt. %, preferably more than 0.5 wt. %, preferably more than 1 wt. %, preferably more than 1.5 wt %, preferably more than 2 wt %. The preservative system typically comprises propionate, preferably in the form of propionic acid and/or a propionic acid salt, in an amount of less than 95 wt. % based on the total weight of the preservative system, less than 60 wt. %, less than 50 wt. %, less than 40 wt. %, less than 30 wt. % or less than 20 wt. %.

As is known by those skilled in the art, propionate can be obtained by fermentation. In the context of this invention, it is highly advantageous to employ propionate obtained by fermentation, in particular a composition obtainable by fermenting glucose, lactose or lactate, particularly lactate, using an appropriate micro-organism, such as propionic acid bacteria. Hence, in a particularly preferred embodiment of the invention the preservative system comprises a ferment or fermentation product as the source of propionate. Such a fermentation product or ferment is typically characterized by the presence of other fermentation products such as acetate, lactate and/or succinate. Hence, in a preferred embodiment of the invention the preservative composition comprises a ferment or fermentation product containing propionate and acetate, the ratio (w/w) of propionate:acetate being more than 1, preferably more than 1.5, most preferably more than 1.75. Said ratio is preferably less than 5, more preferably less than 2.5, most preferably less than 2.25. Said ratio can for example be approximately 2. In another preferred embodiment of the invention the preservative composition comprises a ferment or fermentation product containing propionate and lactate, the ratio (w/w) of propionate:lactate being more than 1, preferably more than 1.25, most preferably more than 1.5. Said ratio is preferably less than 5, more preferably less than 2.5, most preferably less than 2. In another preferred embodiment of the invention the preservative composition comprises a ferment or fermentation product containing propionate, acetate and lactate. Such ferments or fermentation products have very favorable organoleptic profiles, which contribute positively to the taste and flavour characteristics of food products to which they are added. Raw propionate ferments typically comprise propionate in amounts of 0.02 wt % and up to 6 wt %. In an embodiment of the invention such raw ferments may be combined with the other components of the preservative system, yielding a composition that may be used as such. Alternatively, raw propionate ferments may be concentrated, purified, dried, etc., using techniques known to those of average skill in the art.

A further component of the preservative system is nisin. Nisin is a peptide-like antibacterial substance produced by microorganisms such as Lactococcus lactis subsp. lactis (formerly known as Streptococcus lactis). Nisin inhibits a broad range of Gram-positive bacteria. Nisin is a bacteriocin belonging to the lantibiotics group (class I bacteriocins) and has a long history as food preservative. It is to be understood that nisin actually denotes several nisin variants, such as nisin A and nisin Z, which differ in their amino acid sequence, typically only by a single amino acid, the most common variant being nisin A. In accordance with the invention, the nisin is preferably nisin A. The highest activity preparations of nisin contain about 40 million IU per gram. Commercial preparations containing about 1 million IU per gram are available. Nisin has no known toxic effects in humans. It is widely used in a variety of prepared dairy foods for example.

Hence, in a preferred embodiment of the invention, a preservative system as defined herein before is provided containing at least 0.10 mg nisin per g of the preservative system, more preferably at least 0.20 mg nisin per g of the preservative system, most preferably at least 0.25 mg nisin per g of the preservative system. It is to be noted that herein it is assumed that 1 microgram of nisin equals 40 IU. Hence the preferred levels of nisin correspond to activities of at least 4000 IU, at least 8000 IU and at least 10,000 IU, all per g of the preservative system, respectively.

The preservative system of the present invention can optionally include other preservatives. The invention is not particularly limited in this regard.

In one embodiment of the invention, the preservative system further comprises a cinnamic acid component, preferably cinnamic acid and/or one or more salts thereof. Cinnamic acid (3-phenyl-2-propenoic acid) is well known as a food ingredient, which obtained FEMA-GRAS status in 1965. As will be understood by those skilled in the art, any soluble cinnamic acid salt may be used in accordance with the invention. The term ‘cinnamate component’ as used herein encompasses any substance containing the cinnamic acid anion and/or capable of liberating the cinnamate anion and thus includes, besides cinnamic acid and the salts thereof, e.g. certain cinnamic acid esters. A number of cinnamic acid esters are known and used in the food industry, including cinnamyl acetate, cinnamyl benzoate, cinnamyl cinnamate, cinnamyl formate, cinnamyl isobutyrate, cinnamyl isovalerate and cinnamyl phenylacetate, which may also be encompassed by the term ‘cinnamate component’. In accordance with an embodiment of the invention these derivatives are suitable for use in the preservative system either alone or in combination with cinnamic acid or other cinnamate salts.

In a particularly preferred embodiment of the invention the preservative system comprises cinnamic acid and/or a cinnamic acid salt, more preferably cinnamic acid and/or a cinnamic acid salt selected from the group of sodium cinnamate and potassium cinnamate. In a preferred embodiment, the preservative system comprises potassium cinnamate.

In one preferred embodiment, the preservative system comprises the cinnamate component, preferably in the form of cinnamic acid and/or a cinnamic acid salt, in an amount of more than 0.5 wt. %, based on the total weight of the preservative system, preferably more than 1.0 wt. %, preferably more than 1.5 wt. %, preferably more than 2.0 wt. %. The maximum amount of cinnamate is not particularly limited. Embodiments are envisaged, wherein the preservative system comprises the cinnamate component, preferably in the form of cinnamic acid and/or a cinnamic acid salt, in an amount of less than 100 wt. % based on the total weight of the preservative system, less than 90 wt. %, less than 80 wt. %, less than 70 wt. %, less than 60 wt. %, less than 50 wt. %, less than 40 wt. %, less than 30 wt. %, or less than 20 wt. %.

In a preferred embodiment of the invention the preservative composition comprises cinnamate and propionate and the ratio (w/w) cinnamate:propionate is within the range of 30/1-4/1, more preferably 20/1-2/1, most preferably 20/1-1/1.

A particular advantage of the present invention resides in the fact that the presence of other preservatives, especially synthetic preservatives such as benzoates and sorbates can be minimized or avoided altogether while achieving the desired level of microbial stability. The preservative system of the present invention typically contains no or only minor amounts of additional preservative agents, such as, in particular, benzoate and/or sorbate. In a preferred embodiment of the invention the preservative system contains less than 1 wt % of preservative agents selected from the group consisting of sorbates and benzoates, preferably less than 0.5 wt %, preferably less than 0.1 wt %, more preferably less than 0.05 wt %. In a particularly preferred embodiment of the invention the preservative system is essentially or completely free from preservative agents selected from the group of benzoates and sorbates.

In a preferred embodiment of the invention the preservative system contains less than 1 wt % of sodium diacetate, preferably less than 0.5 wt %, preferably less than 0.1 wt %, more preferably less than 0.05 wt %. In a particularly preferred embodiment of the invention the preservative system is essentially or completely free from sodium diacetate.

Furthermore, in a preferred embodiment of the invention the preservative system contains less than 0.25 wt % of lytic enzyme, such as lysozyme, preferably less than 0.10 wt %, preferably less than 0.05 wt %. In a particularly preferred embodiment of the invention the preservative system is essentially or completely free from lytic enzymes, such as lysozyme.

Furthermore, in a preferred embodiment of the invention, the preservative system does not comprise plant or fruit extracts, the oily phases of plant or fruit extracts and monosubstances derived from such extracts or the oily phases thereof, besides the cinnamate component.

In a preferred embodiment of the invention, the preservative system is provided in the form of a free flowing powder consisting essentially of the components discussed here above.

In another embodiment of the invention the preservative composition further comprises a carrier material, the choice of which will largely depend on the physical form in which the preservative system is to be provided. The carrier material is typically used in any amount required to provide a product that has the desired properties relating to production, storage and dosing.

In one embodiment of the invention, a preservative system in the form of a free flowing powder or granulate, comprising one or more carrier materials. Such products may be obtained by combining the various components in an aqueous dispersion or solution followed by drying, e.g. spray-drying.

In another embodiment a liquid preservative system is provided comprising solution or dispersion of the above defined components in an aqueous phase, which for instance may be obtained by concentrating an aqueous dispersion or solution containing the components of the preservative system.

A second aspect of the invention provides a food product comprising an effective amount of a preservative system as described herein. Preferably, a food product is provided comprising an effective amount of propionic acid and/or one or more salts thereof in combination with nisin. More preferably, a food product is provided comprising an effective amount of propionic acid and/or a salt thereof, nisin and cinnamic acid and/or a salt thereof.

As used herein the term ‘effective amount’ refers to an amount sufficient to confer an improvement to the product to which the present preservative system is added relating to one or more of the following:

i) reduced outgrowth of Clostridium botulinum in a food product as defined herein;
ii) reduced germination of Clostridium botulinum in a food product as defined herein
iii) extended shelf-life of a food product as define herein;
iv) enhanced protection of a food product as defined herein against spoilage by Clostridium botulinum;
v) reduced Clostridium botulinum counts in a food product as defined herein;
vi) reduced Clostridium botulinum spore counts in a food product as defined herein;
vii) reduced toxin formation by Clostridium botulinum in a food product as defined herein; and/or
viii) reduced risk of foodborn botulism.

As commonly understood by those skilled in the art, these effects constitute relative improvements, not absolute characteristics. Hence, an effective amount is an amount that confers a noticeable improvement in terms of one or more of the above criteria, as compared to a food product not comprising the present preservative system (but otherwise identical).

In one preferred embodiment, the food product comprises propionate, preferably in the form of propionic acid and/or salts thereof, in an amount of more than 1 ppm, preferably more than 2.5 ppm, preferably more than 5 ppm, preferably more than 10 ppm, preferably more than 25 ppm, preferably more than 50 ppm, preferably more than 100 ppm, preferably more than 200 ppm, preferably more than 300 ppm, preferably more than 400 ppm, most preferably more than 500 ppm. In one preferred embodiment, the food product comprises propionate, preferably in the form of propionic acid and/or salts thereof, in an amount of less than 5000 ppm, preferably less than 2500 ppm, preferably less than 2000 ppm, preferably less than 1500 ppm, preferably less than 1000 ppm, preferably less than 900 ppm, preferably less than 800, preferably less than 700 ppm, ppm, preferably less than 600 ppm. In another preferred embodiment of the invention, a propionate containing ferment, as defined herein before, is incorporated in the food product in an amount providing the recited levels of propionate.

In one preferred embodiment, the food product comprises nisin in an amount of at least 0.001 mg nisin per g of the food product, more preferably at least 0.002 mg nisin per g of the food product, most preferably at least 0.0025 mg nisin per g of the food product. In an embodiment of the invention, the food product will typically comprise less than 0.1 mg nisin per g of the food product, preferably less than 0.05 mg nisin per g of the food product.

In one preferred embodiment, the food product comprises cinnamate, preferably in the form of cinnamic acid and/or salts thereof, in an amount of more than 50 ppm, preferably more than 100 ppm, preferably more than 150 ppm, preferably more than 200 ppm, preferably more than 250 ppm, preferably more than 275 ppm, preferably more than 300 ppm, preferably more than 325 ppm, preferably more than 350 ppm. In one preferred embodiment, the food product comprises cinnamate, preferably in the form of cinnamic acid and/or salts thereof, in an amount of less than 2000 ppm, preferably less than 1500 ppm, preferably less than 1000 ppm, preferably less than 900 ppm, preferably less than 800 ppm, preferably less than 700 ppm, preferably less than 600, preferably less than 500 ppm, preferably less than 400 ppm.

In one embodiment a food product as defined herein above is provided, which contains less than 50 ppm of preservative agents selected from the group of sorbates and benzoates, preferably less than 10 ppm, more preferably less than 5 ppm, more preferably less than 1 ppm, more preferably less than 0.5 ppm, more preferably less than 0.1 ppm and most preferably less than 0.05 ppm. This ensures that no negative taste effects are observed. In a particularly preferred embodiment of the invention the food product is essentially or completely free from preservative agents selected from the group of benzoates and sorbates.

In one embodiment a food product as defined herein above is provided, which contains less than 50 ppm of sodium diactetate, preferably less than 10 ppm, more preferably less than 5 ppm, more preferably less than 1 ppm, more preferably less than 0.5 ppm, more preferably less than 0.1 ppm and most preferably less than 0.05 ppm. In a particularly preferred embodiment of the invention the food product is essentially or completely free from sodium diactetate.

Furthermore, in a preferred embodiment of the invention the food product contains less than 50 ppm of lytic enzyme, such as lysozyme, preferably less than 25 ppm, and preferably less than 10 pp. In a particularly preferred embodiment of the invention the food product is essentially or completely free from lytic enzymes, such as lysozyme.

Furthermore, in a preferred embodiment of the invention, the food product does not comprise plant or fruit extracts, the oily phases of plant or fruit extracts and monosubstances derived from such extracts or the oily phases thereof, besides the cinnamate component.

Preferably, the food product according to the present invention will possess a specified range of acidity, especially a pH of above 4.6. In one preferred embodiment of the invention, the pH is at least 5, preferably at least 5.3, preferably at least 5.6, preferably at least 5.8, preferably at least 6, preferably at least 6.2, preferably at least 6.4, preferably at least 6.65. Furthermore, the invention can provide particular advantages at a water content of at least 30 wt. %, more preferably at least 50 wt. %, more preferably at least 65 wt. %, more preferably at least 80 wt. %. In one embodiment the food product is a high-water food product comprising 65-80 wt. % of water. Typical examples of high-water food products include starchy vegetables and fruit, baked or broiled fish, rice, beans, yoghurt, roasted chicken and turkey, potatoes, cottage cheese and cooked or raw beef. In another preferred embodiment, the food product is a very high-water food product having more than 80 wt. % of water. Typical examples of very high-water food products include soups, broths, stews, sauces and gravies, sprouts, non-starchy vegetables and juices, milk, tofu, soy and rice milk, raw fruits and fruit juices.

The invention can provide particular advantages at high water activities (Aw), typically of above 0.90. In particularly preferred embodiments of the invention, the food product has a water activity above 0.92, above 0.94, above 0.95, above 0.96 or above 0.97.

Furthermore, the invention can provide particular advantages at a salt content below 7 wt. %, based on total weight of the food product. In one preferred embodiment of the invention, the food product has a salt content within the range of 0.01-7, more preferably 0.05-5 wt. %, more preferably 0.1-4.5 wt. %, most preferably 0.2-4 wt. %. In one preferred embodiment of the invention, the food product has a NaCl content within the range of 0.01-7, more preferably 0.05-5 wt. %, more preferably 0.1-4.5 wt. %, most preferably 0.2-4 wt. %.

In one preferred embodiment of the invention, the water phase of the food product has a salt concentration of below 7% (w/v), preferably below 5% (w/v), preferably below 4.5% (w/v), more preferably below 4% (w/v), more preferably below 3.5% (w/v), more preferably below 3% (w/v). In one preferred embodiment of the invention, the water phase of the food product has a NaCl concentration of below 7% (w/v), preferably below 5% (w/v), preferably below 4.5% (w/v), more preferably below 4% (w/v), more preferably below 3.5% (w/v), more preferably below 3% (w/v).

As noted herein before, the present preservative system is particularly suited for use in mildly processed food products. As is generally understood by those skilled in the art, operations like sterilization and UHT generally diminish certain quality aspects of the food product, in particular those associated with the consumer's perception of freshness. Hence, preferably the food product of the present invention has not been subjected to sterilization or UHT treatment. In a preferred embodiment of the invention the food product has not been subjected to any treatments sufficient to effect a 12 decimal (12D) reduction of spores of C. botulinum. In one embodiment of the invention the food product has not been subjected to any treatments sufficient to effect a 6D reduction of spores of C. botulinum.

Decimal reduction is a parameter that is commonly used to specify sterilization treatment. Decimal reduction is the number of powers of 10 that the number of organisms is to be reduced by, i.e. log N₀/N Where N₀ is the initial cell count and N is the number of cells after treatment. The most usual decimal reduction is a “12D” reduction i.e. N₀/N=10¹² and log N₀/N=12. The D-value is defined as the time to reduce the number of organisms by 1 log cycle i.e. N₀/Nₜ=10. The D value is specific to a temperature. Therefore when quoting D-values for an organism, the temperature is also be quoted, usually as a subscript to the “D”. For clostridium botulinum, D₁₂₁=0.2 min. The sterilisation time is often referred to as the “F number”. F is the product of the D-value and the decimal reduction. Thus, for a 12D reduction, F=12 D_{T}. Because C. botulinum is the basis of most food sterilisations, the F value is determined on the basis of a reference temperature of 121° C. In such cases, F is usually designated F₀. For example, for a 12 D reduction of clostridium botulinum, F₀=12×0.2=2.4 min. Hence according to a preferred embodiment of the invention the food product of the invention is a processed food product that has received less heat treatment than the equivalent of 2.4 minutes at 121° C. According to another preferred embodiment of the invention the food product of the invention is a processed food product that has received less heat treatment than the equivalent of 10 minutes at 90° C., which is a treatment resulting in a 6D reduction.

The food product of the invention preferably is not in a frozen state. In an embodiment, the food product of the invention is not in a frozen state and has not been brought or kept in the frozen state As is generally understood by those skilled in the art, freezing generally diminish the fresh character of the food product and/or the consumer's perception of freshness.

In accordance with the present invention, the food product typically is a refrigerated food product, meaning that after the cooking and packaging process, it is transported and stored under refrigeration. The food product of the present invention thus preferably is in a chilled or refrigerated state, i.e. the temperature of the food product is preferably within the range of 0-10° C., preferably within the range of 3-8° C. In a preferred embodiment of the invention, the packaged processed food product is contained within a space kept at a temperature within the range of 0-10° C., preferably within the range of 3-8° C., such as a refrigerator. In a particularly preferred embodiment of the invention, the packaged food product contains instructions printed on the package to store the packaged food product in a refrigerator, preferably at a temperature within the range of 0-10° C., preferably within the range of 3-8° C.

The food product of the invention, according to a preferred embodiment of the invention is a fresh, unprocessed or ‘mildly processed’ food product. In the art, the term ‘mildly processed’ is, typically understood as referring to food products that have received treatments comparable to conventional cooking, as opposed e.g. to highly processed foods. Typically, in accordance with one embodiment of the invention, the food product has been prepared by conventional (industrial) cooking processes, which typically include blending of food ingredients and regular cooking operations such as cooking, braising, simmering, baking, etc., followed by packaging.

The food product of the invention, according to a preferred embodiment of the invention is a perishable food product. In the art, the term ‘perishable’ is, typically used to denote food products that have a measurable, limited shelf life such as fresh and refrigerated food products. Typically, in accordance with one embodiment of the invention, a perishable food product is a food product that, without addition of preservatives, may have a shelf-life of only 1 or 2 weeks, when kept at a temperature within the range of 0-10° C., preferably within the range of 3-8° C. These food products can benefit from the application of cinnamic acid and/or a cinnamic acid salt or a preservative system of the invention to significantly enhance the shelf-life. The food product including a preservative system of the invention, preferably is characterized by having a shelf-life within the range of 7-140 days, preferably within the range of 10-125 days, more preferably 12-115 days, most preferably 14-105 days. As used herein, the shelf-life is defined as the amount of time a product remains acceptable for organoleptic, nutritional, and/or safety purposes, for the consumer or the retailer, after production, when appropriately stored, preferably when stored under refrigeration, preferably at a temperature within the range of 0-10° C., preferably within the range of 3-8° C.

The food product of the invention typically is a convenience food-product, i.e. a food product that can be served with only minimal processing by the consumer. In particular, the convenience food product in accordance with the present invention is a so-called ‘ready-to-serve’ type of food product, typically meaning that it is a food product ready for consumption by a consumer or requiring only heating, e.g. by microwaving, before consumption.

The food product of the present invention is preferably selected from the group consisting of ready meals, soups, sauces, fresh meat, fresh fish or seafood, fresh produce, cut produce, composite foods, dairy products, snacks, processed meat products, cooked meat products, salad dishes, pasta dishes, pizza's, lunch meals. In a preferred embodiment of the invention, the food product is not a pet food product.

Food products in accordance with this invention may be contained in a specific type of package. As is understood by those of average skill in the art, the permeability of the packaging material to gases and the packaging procedure employed can influence the type of organisms that can grow within the package. In the packaging of the type of food products the present invention is primarily concerned with, the use of packaging material with low permeability to gases and packaging under an anaerobic atmosphere is quite common in order to protect against microbial spoilage and thereby preserve the organoleptic qualities of the product. As will be understood by those skilled in the art this type of packaging at the same time enhances the risks of spoilage by pathogenic bactaria, such as Clostridium botulinum. Hence, in an embodiment of the present invention a food product as defined herein is provided, said food product being contained in a package having low permeability to gases, especially oxygen. The package has suitable oxygen barrier properties It is preferred that one or more suitable oxygen barrier materials surround the food product that has an oxygen permeability of no greater than about 1 cc of oxygen per 100 square inches per atmosphere at room temperature (about 25° C.). In an embodiment of the invention, the space within the package that is not occupied by the food product is filled with a gas that differs from normal air, preferably by at least a 10% difference in oxygen content, more preferably a 25% difference, most preferably a 50% difference. In an embodiment of the present invention a food product as defined herein is provided, said food product being contained in a so-called modified atmosphere packaging or an equilibrium modified atmosphere packaging.

In an embodiment of the invention, the package comprises a sealed bag, a sealed cup, a sealed bowl or a sealed tray. In a preferred embodiment, the package is not a cardboard box or a metal can. In a preferred embodiment of the invention, the package at least contains a portion that is transparent so as make the food product contained within the package at least partially visible from the outside. In a preferred embodiment of the invention the package is entirely made of a transparent material.

Yet a further aspect of the invention concerns a method of providing a food product as described herein above, comprising adding to said food product an effective amount of a preservative system of this invention.

In an embodiment of the invention, a method of providing an extended shelf-life processed food product is provided comprising the steps of:

a) preparing a processed food product;
b) adding to said processed food product a preservative system as described herein;
c) packaging said food product; and
d) storing and/or transporting said food product under refrigeration.

In a preferred embodiment of the invention, step a), in its broadest sense, comprises providing one or more food product, preferably a fresh food product, an unprocessed food product or a mildly processed food product and subjecting it to one or more of the following operations: cutting, pealing, crushing, chopping, blending with other food ingredients, heating, cooking, baking, braising and simmering. In a preferred embodiment of the invention, step a) at least comprises combining two or more food ingredients and subjecting the combined food ingredients to cooking, baking, braising and simmering. The processed food product produced in step a) typically will have the characteristics as defined elsewhere in this document, as will be understood by those skilled in the art.

The exact composition of the preservative system and the dosage at which it is applied in step b) are as defined herein elsewhere in relation to the preservative system and the food product respectively.

In a preferred embodiment of the invention, step c) involves packaging techniques as discussed elsewhere in this document, in particular modified atmosphere packaging or equilibrium modified atmosphere packaging, as defined herein before.

In a preferred embodiment of the invention, step d) comprises placing the packaged food product in a space kept at a temperature within the range of 0-8° C., preferably 3-7° C.

In a preferred embodiment of the invention, the method does not include any treatment which is sufficient to effect a 12 decimal (12D) reduction of spores of C. botulinum. In a preferred embodiment of the invention, the method does not include any treatment which is sufficient to effect a 6 decimal (6D) reduction of spores of C. botulinum.

An aspect of the invention concerns the products obtainable by the methods defined here above.

As will be understood by those skilled in the art, the present method has one or more of the following purposes:

i) preventing outgrowth of Clostridium botulinum in a food product as defined herein; and/or
ii) preventing germination of Clostridium botulinum in a food product as defined herein; and/or
iii) extending the shelf-life of a food product as defined herein; and/or
iv) protecting a food product as defined herein against spoilage by Clostridium botulinum; and/or
v) killing Clostridium botulinum bacteria in a food product as defined herein; and/or
vi) inactivating Clostridium botulinum spores in a food product as defined herein; and/or
vii) preventing toxin formation by Clostridium botulinum in a food product as defined herein; and/or
viii) use in a method of preventing foodborne botulism.

An aspect of the present invention, provides the use of a preservative system as described herein for one or more of the purposes i)-vii) as recited above.

Thus, the invention has been described by reference to certain embodiments discussed above. It will be recognized that these embodiments are susceptible to various modifications and alternative forms well known to those of skill in the art.

Many modifications in addition to those described above may be made to the structures and techniques described herein without departing from the spirit and scope of the invention. Accordingly, although specific embodiments have been described, these are examples only and are not limiting upon the scope of the invention.

Furthermore, for a proper understanding of this document and in its claims, it is to be understood that the verb “to comprise” and its conjugations is used in its non-limiting sense to mean that items following the word are included, but items not specifically mentioned are not excluded. In addition, reference to an element by the indefinite article “a” or “an” does not exclude the possibility that more than one of the element is present, unless the context clearly requires that there be one and only one of the elements. The indefinite article “a” or “an” thus usually means “at least one”.

All patent and literature references cited in the present specification are hereby incorporated by reference in their entirety.

The following examples are offered for illustrative purposes only, and are not intended to limit the scope of the present invention in any way.

### EXAMPLES

### Experiment 1

In this experiment the time to toxin of non-proteolytic Clostridium botulinum Type B and E in soups treated with three different combinations of antimicrobials versus a control was measured.

Canned New England clam chowder was used as a sterile product for further inoculation.

Spores of 5 strains of non-proteolytic Clostridium botulinum (Cbot) were selected for inoculation. Three strains of non-proteolytic type B (including 17B) and two strains of non-proteolytic type E (including Beluga) were used. Each strain was tested for toxin production prior to inoculation.

Spore crops were prepared from selected strains using a biphasic method and tested for toxin production via mouse bioassay.

Spore crops were enumerated by pour plating onto Liver-Veal Agar (LVA) and Shahidi-Ferguson Perfringens (SFP) Agar and incubated for 7 days at 27° C. under anaerobic conditions.

Spore mixtures used as inocula contained approximately equal numbers of spores of each strain of C. botulinum in the cocktail. Spore counts were performed for each strain before the spores were pooled into the cocktail. Spores were diluted appropriately in sterile distilled water and stored at −20° C.

Triplicate samples of the soup were inoculated with 10³ spores per 50 ml and left untreated or treated with various preservative systems of the invention (see table 1 below). Potassium cinnamate was used in the form of a 99% pure product. Propionic acid was added in the form of a concentrated ferment containing +/−20% of propionic acid (commercially available under the brand from Corbion under the brand ‘Verdad F95’). A commercial nisin preparation containing 2.5% (w/w) nisin was used.

Triplicate samples of a negative control containing no antimicrobials were evaluated for APC and mesophilic anaerobic spore counts at each pull time to monitor any possible background growth.

TABLE 1
preservative systems

Test Combinations (in % (w/w) in soup)

| Example # | 1 | 2 | 3 | 4 |
|---|---|---|---|---|
| KCin | 0 | 0 | 0.035 | 0 |
| Propionic | 0 | 0.16 | 0.16 | 0.1 |
| acid | | | | |
| Nisin | 0 | 0.0005 | 0.0005 | 0.001 |

The potassium cinnamate, propionic acid and nisin containing compositions were mixed into the soup followed by spore cocktail inoculation. Following inoculation, the food sample was heat treated at 71° C. for 10 min and chilled rapidly to 4° C. using an ice bath. The soup was subsequently repackaged in vacuum and sealed in a high barrier bag and stored at 7° C. over a 20 week period.

Shelf-life trials were conducted for 128 days at 7° C. (temperature monitored daily) with analyses at every 21 day interval (Day 0, 21, 42, 63, 74, 85, 96, 107, 128) comprising C. botulinium toxin test (50 ml) using mouse bioassay (9 data points). For this purpose, sample (50 ml) was homogenized in gel phosphate buffer (1:1) and extracted for botulinal toxin testing according to FDA BAM and resulting samples stored in aliquots at −20° C. To avoid diluting out the sample, initial tests involving centrifugation of food matrices directly and then filtered will be performed and evaluated. Samples were tested for the presence of toxin by mouse bioassay. Extracted samples were divided into three aliquots. The first aliquot was treated with trypsin for 1 hr at 35° C. to potential type E toxin. The second aliquot was boiled for 10 min to serve as a negative control during conformations. The third aliquot was not trypsin-treated and not boiled. A fourth aliquot containing a known quantity of botulism toxin served as a positive control. Once a positive result was obtained in an experiment, the experiment in question was terminated. The results are summarized in tables 2 and 3 below.

TABLE 2
Microbiological counts of negative control

| | | | Mesophloic | |
|---|---|---|---|---|
| | | Aerobic counts | anaerobic spores | |
| | Replicate | (CFU/g) | (CFU/g) | Toxin |
| Week 0 | 1 | <10 | <10 | Negative |
| | 2 | <10 | <10 | Negative |
| | 3 | <10 | <10 | Negative |
| Week 3 | 1 | <10 | <10 | |
| | 2 | <10 | <10 | |
| | 3 | <10 | <10 | |
| Week 6 | 1 | <10 | <10 | |
| | 2 | <10 | <10 | |
| | 3 | <10 | <10 | |
| Week 9 | 1 | <10 | <10 | |
| | 2 | <10 | <10 | |
| | 3 | <10 | <10 | |
| Week 11 | 1 | <10 | <10 | |
| | 2 | <10 | <10 | |
| | 3 | <10 | <10 | |
| Week 13 | 1 | <10 | <10 | |
| | 2 | <10 | <10 | |
| | 3 | <10 | <10 | |
| Week 15 | 1 | <10 | <10 | |
| | 2 | <10 | <10 | |
| | 3 | <10 | <10 | |
| Week 17 | 1 | <10 | <10 | |
| | 2 | <10 | <10 | |
| | 3 | <10 | <10 | |
| Week 19 | 1 | <10 | <10 | |
| | 2 | <10 | <10 | |
| | 3 | <10 | <10 | |

TABLE 3
C. botulinum toxin results for inoculated samples

| | Replicate | Exp. 1 | Exp. 2 | Exp. 3 | Exp. 4 |
|---|---|---|---|---|---|
| Week 0 | 1 | Negative | Negative | Negative | Negative |
| | 2 | Negative | Negative | Negative | Negative |
| | 3 | Negative | Negative | Negative | Negative |
| Week 3 | 1 | Negative | Negative | Negative | Negative |
| | 2 | Negative | Negative | Negative | Negative |
| | 3 | Negative | Negative | Negative | Negative |
| Week 6 | 1 | Negative | Negative | Negative | Negative |
| | 2 | Negative | Negative | Negative | Negative |
| | 3 | Positive | Negative | Negative | Negative |
| Week 9 | 1 | | Positive | Negative | Negative |
| | 2 | | Negative | Negative | Negative |
| | 3 | | Positive | Negative | Negative |
| Week 11 | 1 | | | Negative | Negative |
| | 2 | | | Negative | Negative |
| | 3 | | | Negative | Negative |
| Week 13 | 1 | | | Negative | Negative |
| | 2 | | | Negative | Negative |
| | 3 | | | Negative | Positive |
| Week 15 | 1 | | | Negative | |
| | 2 | | | Negative | |
| | 3 | | | Negative | |
| Week 17 | 1 | | | Negative | |
| | 2 | | | Negative | |
| | 3 | | | Negative | |
| Week 19 | 1 | | | Negative | |
| | 2 | | | Negative | |
| | 3 | | | Negative | |

1. A method for:
i) preventing outgrowth of Clostridium botulinum in a food product; and/or
ii) preventing germination of Clostridium botulinum in a food product; and/or
iii) extending the shelf-life of a processed food product; and/or
iv) protecting a food product against spoilage by Clostridium botulinum; and/or
v) killing Clostridium botulinum bacteria in a food product; and/or
vi) inactivating Clostridium botulinum spores in a food product; and/or
vii) preventing toxin formation by Clostridium botulinum in a food product; and/or
viii) preventing foodborne botulism;
said method comprising incorporating into a food product a preservative system comprising i) propionic acid or a salt thereof and ii) nisin.

2. The method according to claim 1, wherein the food product has a water content of at least 50 wt %, based on the total weight of the product, and a water activity of above 0.90, preferably above 0.94

3. The method according to claim 1, wherein the food product has a pH of above 4.6.

4. The method according to claim 1, wherein the preservative system is incorporated in the food product in an amount providing a propionate level of at least 200 ppm and a nisin level of at least 0.001 mg per gram of the food product.

5. The method according to claim 1 wherein the preservative system further comprises cinnamic acid or a salt thereof.

6. Method of providing an extended shelf-life processed food product comprising the steps of:
a) preparing a processed food product;
b) adding to said processed food product a preservative system comprising i) propionic acid or a salt thereof and ii) nisin;
c) packaging said food product; and
d) storing and/or transporting said food product under refrigeration.

7. Method according to claim 6, wherein the method does not include any treatment which is sufficient to effect a 12 decimal (12D) reduction of spores of C. botulinum

8. Method according to claim 6, wherein step c) comprises modified atmosphere packaging or equilibrium modified atmosphere packaging.

9. Extended shelf-life food product obtainable by the method according to claim 6.

10. Food product having a moisture content of above 65 wt. % and a water activity of above 0.90, said food product comprising at least 200 ppm of propionic acid or a salt thereof, and at least 0.001 mg of nisin per gram of the food product.

11. Food product according to claim 10, wherein the food product has a pH of above 4.6.

12. Food product according to claim 10, wherein the food product has a salt content within the range of 0.01-5 wt. %.

13. Food product according to claim 10, having a shelf life of between 7 and 140 days at a temperature of between 0 and 10° C.

14. Food product according to claim 10, wherein the food product further comprises cinnamic acid or a salt thereof.

15. Food product according to claim 10, wherein food product is packaged and contains instructions printed on the package to store the food product in a refrigerator.

16. Food product according to claim 10, wherein the food product has not been subjected to a treatment which is sufficient to effect a 12 decimal (12D) reduction of spores of C. botulinum.
